(19) United States
(12) Patent Application Publication
(10) Pub. No.: US 2017/0123229 A1
(43) Pub. Date: May 4, 2017

(54) METHOD FOR MAKING A COLORANT FILM, COLORANT FILM, AND OPHTHALMIC LENS

(71) Applicant: HON HAI PRECISION INDUSTRY CO., LTD., New Taipei (TW)

(72) Inventor: HSIU-WEN CHIEN, New Taipei (TW)

(21) Appl. No.: 14/961,135

(22) Filed: Dec. 7, 2015

(30) Foreign Application Priority Data
Nov. 4, 2015 (TW) 104136396

(51) Int. Cl. G02C 7/04; G02B 5/22; B29C 41/46; C08F 222/38

(52) U.S. Cl. CPC G02C 7/046; C08F 222/38; G02B 5/223; B29C 41/46; B29K 2083/00

(57) ABSTRACT

A method for making a colorant film includes following steps of mixing a hydrophilic monomer, a vinyl monomer including catechol groups, a cross-linking agent, and an initiator to form a mixture; adding an active pigment and a solvent into the mixture to form a colorant material; printing the colorant material into a mold; and heating or irradiating the colorant material in the mold by ultraviolet light to make the hydrophilic monomer, vinyl monomer with catechol groups, the initiator, and the cross-linking agent to copolymerize. The disclosure also provides a colorant film, and an ophthalmic lens.

### FIELD

The subject matter herein generally relates to a colorant film, a method for making the colorant film, and an ophthalmic lens using the colorant film.

### BACKGROUND

People who do not have good eyesight use ophthalmic lens to improve their eyesight.

### BRIEF DESCRIPTION OF THE DRAWINGS

Implementations of the present technology will now be described, by way of example only, with reference to the attached figures.

FIG. 1 is a flowchart of an embodiment of a method for making a colorant film.

FIG. 2 is a cross-sectional view of an embodiment of an ophthalmic lens.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

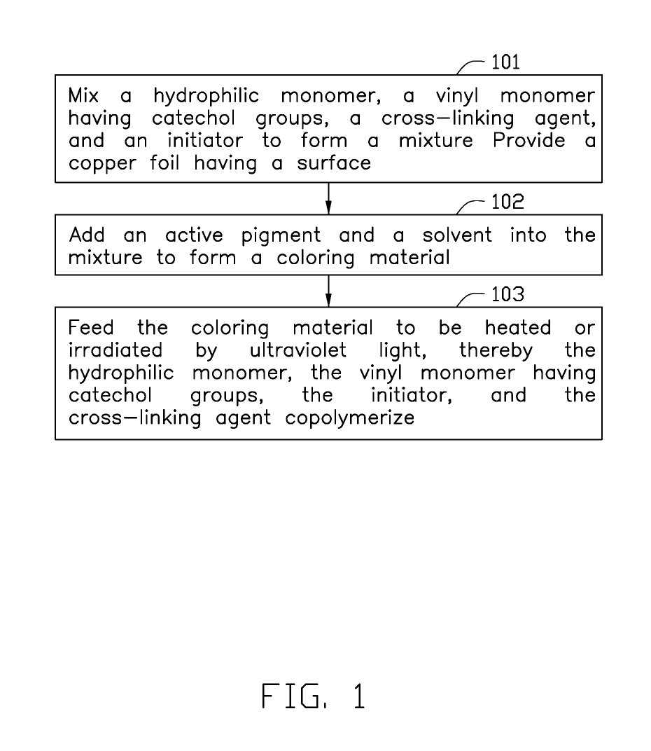

FIG. 1 illustrates a flowchart of a method for making a colorant film in accordance with an exemplary embodiment. The exemplary method is provided by way of example, as there are a variety of ways to carry out the method. Each block shown in FIG. 1 represents one or more processes, methods or subroutines, carried out in the exemplary method. Furthermore, the illustrated order of blocks is by example only and the order of the blocks can change. Additional blocks may be added or fewer blocks may be utilized, without departing from this disclosure. The exemplary method can begin at block 101.

At block 101, a mixture is formed by mixing a hydrophilic monomer, a vinyl monomer comprising catechol groups, a cross-linking agent, and an initiator. The hydrophilic monomer has a mass percentage of about 42% to about 78% in the mixture. The vinyl monomer comprising catechol groups has a mass percentage of about 0.5% to about 15% in the mixture. The cross-linking agent has a mass percentage of about 10% to about 38% in the mixture. The initiator has a mass percentage of about 1% to about 8% in the mixture.

The hydrophilic monomer may be selected from methacrylate compounds and/or acrylate compounds, such as 2-hydroxyethyl methacrylate (HEMA), methyl methacrylate (MMA), poly(dimethylsiloxane), 3-methacryloxypropyltris(trimethylsiloxy)silane, N-vinyl pyrrolidone (NVP), glycidyl methacrylate, N,N-dimethylacrylamide, and methyl acrylate (MA), or any combination thereof.

The vinyl monomer comprising catechol groups may be selected from a group consisting of dopamine methacrylamide, dopamine methacrylamide derivative, dopamine methacrylate, and dopamine methacrylate derivative. The dopamine methacrylamide has a chemical formula:

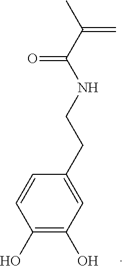 [SMILES: C=C(C)C(=O)NCCc1ccc(O)c(O)c1]

The dopamine methacrylamide derivative has a chemical formula:

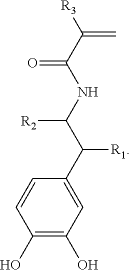

The dopamine methacrylate has a chemical formula:

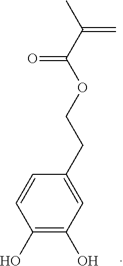 [SMILES: C=C(C)C(=O)OCCc1ccc(O)c(O)c1]

The dopamine methacrylate derivative has a chemical formula:

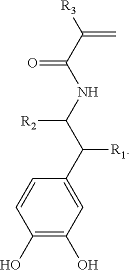

R₁, R₂, and R₃ may be the same or different substituent groups.

The cross-linking agent may be selected from a group consisting of ethylene glycol dimethacrylate (EGDMA) and trimethylolpropane trimethacrylate (TMPTMA). The initiator may be selected from a group consisting of azodiisobutyrodinitrile (AIBN), and an initiator under the trade name “Irgacure-1173” available commercially from Chemical Industries Basel Corporation.

At block 102, an active pigment and a solvent are added into the mixture to form a colorant material. The active pigment may be an active pigment comprising active groups and is widely used in contact lenses, such as C.I. Reactive Blue 19, C.I. Reactive Red 11, and C.I. Reactive Yellow 15, or any combination thereof. The solvent may be selected from a group consisting of toluene and methanol. The mixture has a mass percentage of about 24% to about 78% in the colorant material. The active pigment has a mass percentage of about 17% to about 45% in the colorant material. The solvent has a mass percentage of about 5% to about 31% in the colorant material.

At block 103, the colorant material is printed into a mold and is heated or irradiated by ultraviolet light, then the hydrophilic monomer, the vinyl monomer comprising catechol groups, the initiator, and the cross-linking agent copolymerize to form a colorant film. In at least one embodiment, the colorant film has a thickness of about 1 μm to about 40 μm. The heating or the ultraviolet irradiation of the colorant material in the mold may last for about 10 seconds to about 120 seconds. The solvent is vaporized to be removed during the heating or ultraviolet light irradiation process.

The catechol groups of the vinyl monomer react with the active groups (such as amine group) of the active pigment to form covalent bonds, thereby enhancing an adhesion of the active pigment and preventing the active pigment from releasing from the colorant film.

### Example 1

A mixture was formed by mixing 2-hydroxyethyl methacrylate, dopamine methacrylamide, azodiisobutyrodinitrile, and ethylene glycol dimethacrylate. The 2-hydroxyethyl methacrylate had a mass percentage of 68% in the mixture. The dopamine methacrylamide had a mass percentage of 12.2% in the mixture. The azodiisobutyrodinitrile had a mass percentage of 3% in the mixture. The ethylene glycol dimethacrylate had a mass percentage of 16.8% in the mixture. A colorant material was formed by adding C.I. Reactive Blue 19 and toluene into the mixture. The mixture had a mass percentage of 31% in the colorant material. The C.I. Reactive Blue 19 had a mass percentage of 38% in the colorant material. The toluene had a mass percentage of 31% in the colorant material. The colorant material was printed into a mold and was irradiated by ultraviolet light for 45 seconds, thereby forming a colorant film.

### Example 2

A mixture was formed by mixing 2-hydroxyethyl methacrylate, dopamine methacrylamide, Irgacure-1173, and ethylene glycol dimethacrylate. The 2-hydroxyethyl methacrylate had a mass percentage of 75% in the mixture. The dopamine methacrylamide had a mass percentage of 5.5% in the mixture. The Irgacure-1173 had a mass percentage of 4.5% in the mixture. The ethylene glycol dimethacrylate had a mass percentage of 15% in the mixture. A colorant material was formed by adding C.I. Reactive Red 11 and toluene into the mixture. The mixture had a mass percentage of 49% in the colorant material. The C.I. Reactive Red 11 had a mass percentage of 41% in the colorant material. The toluene had a mass percentage of 10% in the colorant material. The colorant material was printed into a mold and was irradiated by ultraviolet light for 10 seconds, thereby forming a colorant film.

### Example 3

A mixture was formed by mixing methyl methacrylate, dopamine methacrylate, azodiisobutyrodinitrile, and trimethylolpropane trimethacrylate. The methyl methacrylate had a mass percentage of 78% in the mixture. The dopamine methacrylate had a mass percentage of 1.8% in the mixture. The azodiisobutyrodinitrile had a mass percentage of 3% in the mixture. The trimethylolpropane trimethacrylate had a mass percentage of 17.2% in the mixture. A colorant material was formed by adding C.I. Reactive Blue 19 and methanol into the mixture. The mixture had a mass percentage of 65% in the colorant material. The C.I. Reactive Blue 19 had a mass percentage of 30% in the colorant material. The methanol had a mass percentage of 5% in the colorant material. The colorant material was printed into a mold and was irradiated by ultraviolet light for 60 seconds, thereby forming a colorant film.

A colorant material used in the method for making the colorant film is provided herein. The colorant material comprises an active pigment, a solvent, and a mixture of a hydrophilic monomer, a vinyl monomer comprising catechol groups, a cross-linking agent, and an initiator. The hydrophilic monomer has a mass percentage of about 42% to about 78% in the mixture. The vinyl monomer comprising catechol groups has a mass percentage of about 0.5% to about 15% in the mixture. The cross-linking agent has a mass percentage of about 10% to about 38% in the mixture. The initiator has a mass percentage of about 1% to about 8% in the mixture. The mixture has a mass percentage of about 24% to about 78% in the colorant material. The active pigment has a mass percentage of about 17% to about 45% in the colorant material. The solvent has a mass percentage of about 5% to about 31% in the colorant material. When the colorant material is heated or irradiated by ultraviolet light, the hydrophilic monomer, the vinyl monomer comprising catechol groups, the initiator, and the cross-linking agent copolymerize to form the colorant film.

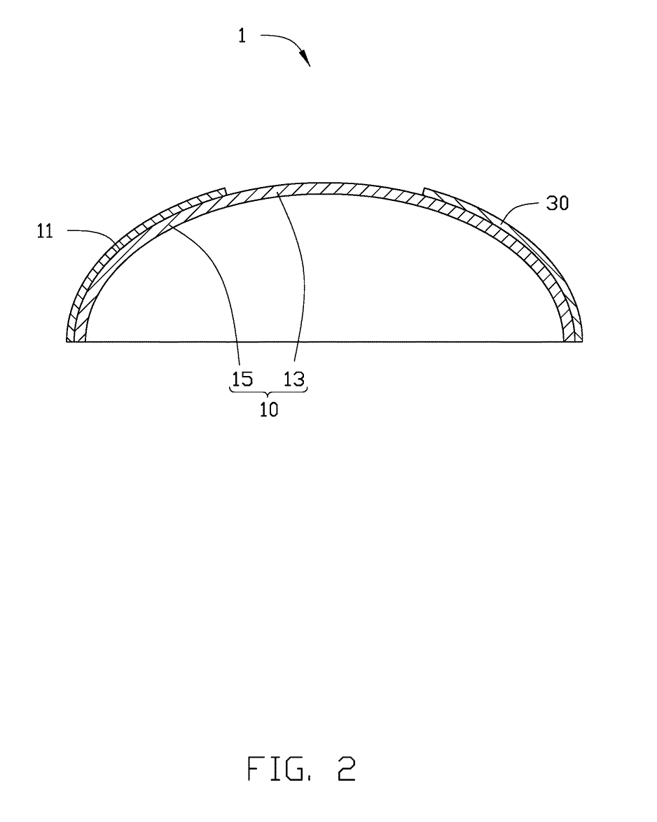

FIG. 2 illustrates an embodiment of an ophthalmic lens 1. The ophthalmic lens 1 comprises a substrate 10 and a colorant film 30 attached to a surface 11 of the substrate 10. The substrate 10 may be made of hydrogel or silicone hydrogel. The substrate 10 comprises a non-opaque pupil region 13 and a generally annular-shaped iris region 15 surrounding the non-opaque pupil region 13. The colorant film 30 covers the generally annular-shaped iris region 15. The colorant film 30 comprises the active pigment and a matrix copolymerized from the hydrophilic monomer, the vinyl monomer comprising catechol groups, the cross-linking agent, and the initiator. The active pigment is dispersed in the matrix, and the active pigment is bonded to the vinyl monomer through covalent bonds formed by catechol groups of the vinyl monomer and active groups (such as amine group) of the active pigment. In at least one embodiment, the colorant film has a thickness of about 1 μm to about 40 μm. To manufacture the ophthalmic lens 1, the colorant film 30 is made by the above-described method. After the colorant film 30 is formed in the mold, material for forming the substrate 10 is added into the mold, and is irradiated by ultraviolet light to form the substrate 10; thereby attaching the colorant film 30 to the surface 11 of the substrate 10. The catechol groups of the colorant film 30 react with groups (such as amine groups) of the substrate 10 to form covalent bonds, thereby enhancing an adhesion between the colorant film 30 and the substrate 10, and preventing the colorant film 30 from peeling from the substrate 10.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A method for making a colorant film comprising:
mixing a hydrophilic monomer, a vinyl monomer comprising catechol groups, a cross-linking agent, and an initiator together to form a mixture;
adding an active pigment and a solvent into the mixture to form a colorant material;
printing the colorant material into a mold; and
heating the colorant material in the mold or irradiating the colorant material in the mold by ultraviolet light to copolymerize the hydrophilic monomer, vinyl monomer comprising catechol groups, the initiator, and the cross-linking agent.

2. The method of claim 1, wherein the hydrophilic monomer has a mass percentage of about 42% to about 78% in the mixture, the vinyl monomer comprising catechol groups has a mass percentage of about 0.5% to about 15% in the mixture, the cross-linking agent has a mass percentage of about 10% to about 38% in the mixture, the initiator has a mass percentage of about 1% to about 8% in the mixture, the mixture has a mass percentage of about 24% to about 78% in the colorant material, the active pigment has a mass percentage of about 17% to about 45% in the colorant material, the solvent has a mass percentage of about 5% to about 31% in the colorant material.

3. The method of claim 2, wherein the vinyl monomer comprising catechol groups is selected from a group consisting of dopamine methacrylamide, dopamine methacrylamide derivative, dopamine methacrylate, and dopamine methacrylate derivative.

4. The method of claim 2, wherein the hydrophilic monomer is selected from methacylate compounds and/or acrylate compounds.

5. The method of claim 4, wherein the hydrophilic monomer is selected from a group consisting of 2-hydroxyethyl methacrylate, methyl methacrylate, poly(dimethylsiloxane), 3-methacryloxypropyltris(trimethylsiloxy)silane, N-vinyl pyrrolidone, glycidyl methacrylate, N,N-dimethylacrylamide, and methyl acrylate.

6. A colorant film comprising:
an active pigment; and
a matrix copolymerized from a hydrophilic monomer, a vinyl monomer comprising catechol groups, an initiator, and a cross-linking agent;
wherein the active pigment is dispersed in the matrix, and the active pigment is bonded to the vinyl monomer through covalent bonds formed by catechol groups of the vinyl monomer and active groups of the active pigment.

7. The colorant film of claim 6, wherein the colorant film is formed by heating or by irradiating a colorant material with ultraviolet light, the colorant material comprises the active pigment, a mixture comprising the hydrophilic monomer, the vinyl monomer comprising catechol groups, the initiator, the cross-linking agent, and a solvent, the hydrophilic monomer has a mass percentage of about 42% to about 78% in the mixture, the vinyl monomer comprising catechol groups has a mass percentage of about 0.5% to about 15% in the mixture, the cross-linking agent has a mass percentage of about 10% to about 38% in the mixture, the initiator has a mass percentage of about 1% to about 8% in the mixture, the mixture has a mass percentage of about 24% to about 78% in the colorant material, the active pigment has a mass percentage of about 17% to about 45% in the colorant material, the solvent has a mass percentage of about 5% to about 31% in the colorant material.

8. The colorant film of claim 7, wherein the vinyl monomer comprising catechol groups is selected from a group consisting of dopamine methacrylamide, dopamine methacrylamide derivative, dopamine methacrylate, and dopamine methacrylate derivative.

9. The colorant film of claim 7, wherein the hydrophilic monomer is selected from methacrylate compounds and/or acrylate compounds.

10. The colorant film of claim 7, wherein the hydrophilic monomer is selected from a group consisting of 2-hydroxyethyl methacrylate, methyl methacrylate, poly(dimethylsiloxane), 3-methacryloxypropyltris(trimethylsiloxy)silane, N-vinyl pyrrolidone, glycidyl methacrylate, N,N-dimethylacrylamide, and methyl acrylate.

11. An ophthalmic lens comprising:
a substrate made of a hydrogel or a silicone hydrogel; and
a colorant film attached to a surface of the substrate;
wherein the colorant film comprises an active pigment and a matrix, the matrix is copolymerized from a hydrophilic monomer, a vinyl monomer comprising catechol groups, an initiator, and a cross-linking agent, and the active pigment is dispersed in the matrix, and the active pigment is bonded to the vinyl monomer through covalent bonds formed by catechol groups of the vinyl monomer and active groups of the active pigment.

12. The ophthalmic lens of claim 11, wherein the colorant film is formed by heating or by irradiating a colorant material with ultraviolet light, the colorant material comprises the active pigment, a mixture comprising the hydrophilic monomer, the vinyl monomer comprising catechol groups, the initiator, the cross-linking agent, and a solvent, the hydrophilic monomer has a mass percentage of about 42% to about 78% in the mixture, the vinyl monomer comprising catechol groups has a mass percentage of about 0.5% to about 15% in the mixture, the cross-linking agent has a mass percentage of about 10% to about 38% in the mixture, the initiator has a mass percentage of about 1% to about 8% in the mixture, the mixture has a mass percentage of about 24% to about 78% in the colorant material, the active pigment has a mass percentage of about 17% to about 45% in the colorant material, the solvent has a mass percentage of about 5% to about 31% in the colorant material.

13. The ophthalmic lens of claim 12, wherein the vinyl monomer comprising catechol groups is selected from a group consisting of dopamine methacrylamide, dopamine methacrylamide derivative, dopamine methacrylate, and dopamine methacrylate derivative.

14. The ophthalmic lens of claim 12, wherein the hydrophilic monomer is selected from methacylate compounds and/or acrylate compounds.

15. The ophthalmic lens of claim 12, wherein the hydrophilic monomer is selected from a group consisting of 2-hydroxyethyl methacrylate, methyl methacrylate, poly(dimethylsiloxane), 3-methacryloxypropyltris(trimethylsiloxy)silane, N-vinyl pyrrolidone, glycidyl methacrylate, N,N-dimethylacrylamide, and methyl acrylate.

16. The ophthalmic lens of claim 11, wherein the colorant film has a thickness of 1 μm to 40 μm.

17. The ophthalmic lens of claim 11, wherein the substrate comprises a non-opaque pupil region and a generally annular-shaped iris region surrounding the non-opaque pupil region, the colorant film covers the generally annular-shaped iris region.
